(19) United States
(12) Patent Application Publication
(10) Pub. No.: US 2003/0019115 A1
(43) Pub. Date: Jan. 30, 2003

(54) Creatinine clearance calculator

(76) Inventor: Hyman Tannenbaum, Dollard des Ormeaux (CA)

Correspondence Address: Mark B. Eisen, Dimock Stratton Clarizio, 20 Queen Street West, Suite 3202, Box 102, Toronto, ON, M5H 3R3, CA

(21) Appl. No.: 09/911,698

(22) Filed: Jul. 25, 2001

(51) Int. Cl. G01B 3/00

(52) U.S. Cl. 33/1 SB

(57) ABSTRACT

A device for calculating the Glomerular Filtration Rate (GFR) of a patient as a marker or renal function, which is user-friendly, portable, and provides a virtually instantaneous patient-specific calculation of the GFR. The device comprises a hand-held precision slide ruler instrument from which calculation of the GFR is obtained from a measured creatinine level in combination with body weight, sex, and age. In the preferred embodiment the device can give results for both males and females by providing gender-specific scales on either face of the instrument. An electronic version may be implemented in a portable or other processing device.

### FIELD OF INVENTION

This invention relates to diagnostic instruments. In particular, this invention relates to a device for establishing renal function by utilizing blood serum creatinine level in combination with body weight, sex, and age to calculate a patient's Glomerular Filtration Rate.

### BACKGROUND OF THE INVENTION

Creatinine is a chemical derived from muscle tissue and is used in clinical practice as a marker of renal function. Serum creatinine levels increase in proportion to an individual's muscle mass, and high values are found in heavier individuals. Men have higher serum creatinine values than women for a given body mass.

As kidney function deteriorates with age, the serum creatinine level also increases. Most routine laboratories list the normal range of serum creatinine at between 70 to 130 μmol/L. However, a physician reviewing a creatinine value of 100 on a routine blood test seldom factors in the variables of the patient age, weight, and sex in assessing the result. For example, a serum creatinine value of 100 in a 50 kg female, age 65 would indicate her kidney is functioning at a Glomerular Filtration Rate (GFR) of 37.5 ml/min, whereas the same creatinine value in a 70 kg male, age 65, would indicate a GFR value of 63.0 ml/min. GFR values of less than 60 ml/min indicate that the kidney is functioning at less than 50% of normal function. Given a serum creatinine value of 100, the 50 kg female might be subject to a medication overdose if the drug were eliminated by the kidney; whereas no ill effect would be experienced by the 70 kg male having the same serum creatinine value of 100.

Having an accurate measure of the GFR can be extremely important in certain situations. It is estimated that five to ten percent of hospital admissions are iatrogenically caused by misuse of drug medications or drug-drug interactions. A significant number of these cases involves patients with impaired renal function, especially patients receiving antihypertensive, anti-neoplastic or antibiotic medications. This is essential in certain environments, for example intensive care units, where changes in renal status are extremely important in determining medication dosage.

The Cockcroft-Gault formula, which is used to determine the Glomerular Filtration Rate based on the serum creatinine level of a female patient, involves three variables as follows:

$$GFR = \frac{( 140 - age ) \times weight}{serum creatinine}$$

in which

age=the age of the patient in years,

weight=the weight of the patient in kilograms, and

serum creatinine=the serum creatinine level in μmol/litre.

To obtain the corresponding GFR value for a male patient, the female value is multiplied by 1.2, i.e.

GFR(male)=1.2×GFR(female)

However, in many cases physicians, nurses and other health care providers prescribe or administer medications based on a rough estimate of the GFR which considers only the serum creatinine level, because a tool for calculating the GFR of a specific patient is not readily available.

The development of a simple GFR tool which is user-friendly, portable and provides a virtually instantaneous calculation would impact greatly on the five to ten percent of hospital admissions that are iatrogenically caused by misuse of drug medications or drug-drug interactions.

### SUMMARY OF THE INVENTION

The present invention provides a device for calculating the Glomerular Filtration Rate (GFR) which is user-friendly, portable, and provides a virtually instantaneous calculation of the GFR based upon an application of the Cockcroft-Gault formula specific to the patient being diagnosed. The device of the invention would be particularly useful in assisting nephrologists, oncologists, infectious disease experts, cardiologists, hospital pharmacists and intensive care unit personnel, as well as other healthcare providers, in correctly prescribing doses of medications in patients with renal impairment.

One preferred embodiment the device comprises a hand-held precision sliding ruler instrument designed to provide an indication of renal function by utilizing a measurement of a patient's serun creatinine level in combination with body weight, sex, and age. In the preferred embodiment the device can give results for both males and females by providing gender-specific scales on either face of the instrument.

The device of the invention is thus well suited for use by physicians and other healthcare providers for monitoring renal status, and in particular the effect of medications on renal function. It is also useful for assisting physicians in calculating the correct dosage of medications to be used in patients with renal impairment. Because of its portability, ease of use and virtually instantaneous results, the device of the invention is also particularly useful for attending physicians making ward rounds in hospitals and emergency room healthcare providers requiring quick access to renal calculations.

The present invention thus provides a device for calculating a Glomular Filtration Rate of a patient, comprising a substantially planar frame, an internal slide disposed within the frame in sliding relation, slidable in a longitudinal direction through the frame, first and second sets of linear mating edges disposed between the frame and the internal slide, the first set of mating edges providing a first mating edge comprising a weight scale representing a logarithmic equivalent to a weight of the patient and a second mating edge comprising a creatinine scale representing a logarithmic equivalent to a creatinine level of the patient, the second set of mating edges providing a third mating edge comprising an age scale representing an age of the patient and a fourth mating edge comprising a GFR scale representing a logarithmic equivalent to a Glomular Filtration Rate of the patient, whereby when the weight of the patient in the weight scale 30 is aligned with the creatinine level of the patient in the creatinine scale, Glomular Filtration Rate of the patient on the GFR scale is aligned with the age of the patient in the age scale.

In further aspects of the invention: the internal slide comprises tongues slidably received in grooves in the frame; the device further comprises an external slide comprising a hollow body slidably received over the frame; the external slide comprises a crosshair to assist in visually aligning values on the scales; the frame and internal slide have opposite faces, the scales on the opposite faces being adapted to calculate the Glomular Filtration Rate of patients of opposite sexes; and/or the scales are calculated by a computer and printed on the device.

### BRIEF DESCRIPTION OF THE DRAWINGS

In drawings which illustrate by way of example only a preferred embodiment of the invention,

FIG. 1 is a front elevation of a device embodying the invention showing scales for calculating the GFR of a female patient,

FIG. 2 is a rear elevation of the device of FIG. 1 showing scales for calculating the GFR of a male patient,

FIG. 3 is a cross-sectional perspective view of the device of FIG. 1,

FIG. 4 is a front elevation of a further embodiment of the device of FIG. 1 having a different weight scale,

FIG. 5 is a rear elevation of the device of FIG. 4, and

FIG. 6 is a front elevation of a hand-held electronic calculating device for calculating the GFR of a male or female patient.

### DETAILED DESCRIPTION OF THE INVENTION

As noted above, the Cockcroft-Gault formula, which is used to determine the Glomerular Filtration Rate based on the serum creatinine level of a female patient is as follows:

$$GFR = \frac{( 140 - age ) \times weight}{serum creatinine} \qquad ( 1 )$$

in which

age=the age of the patient in years,

weight=the weight of the patient in kilograms, and

serum creatinine=the serum creatinine level in μmol/litre.

To obtain the corresponding GFR value for a male patient, the female value is multiplied by 1.2, as follows:

GFR(male)=1.2×GFR(female) (2)

This formula can be adapted to imperial units by a simple unit conversion, as follows:

$$GFR = \frac{( 140 - age ) \times ( weight / 2.2 )}{( serum creatinine \times 88.4 )} \qquad ( 3 )$$

in which

age=the age of the patient in years,

weight=the weight of the patient in pounds, and

serum creatinine=the serum creatinine level in mg/decilitre.

Again, formula (3) is the female case, and the male case is obtained by multiplying the result by 1.2. The value of 88.4 is the conversion factor needed for converting serum creatinine from metric or SI units of μmol/L to imperial units of mg/dL.

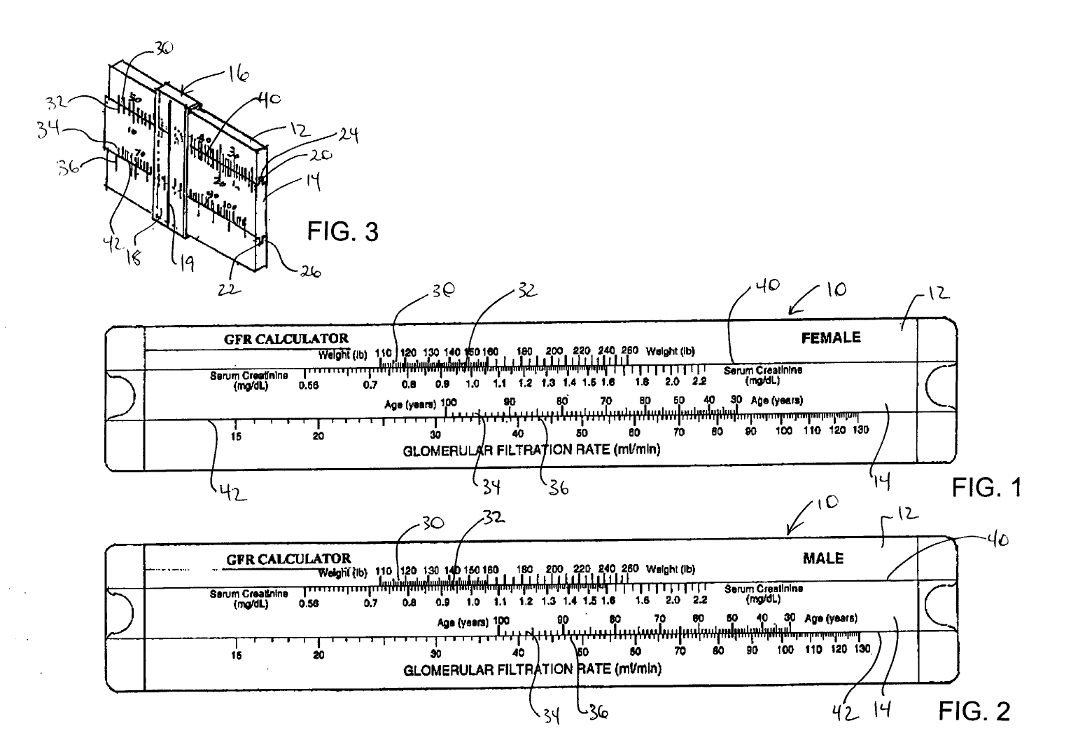

FIGS. 1 and 2 illustrate a first preferred embodiment of the invention for solving the GFR according to the above formula on a patient-specific basis. A sliding ruler 10 comprises a substantially planar frame 12 supporting an internal slide 14 and an external slide 16 in sliding relation. As can be seen in FIG. 3, in the preferred embodiment the internal slide 14 comprises tongues 20, 22 which are slidably received in grooves 24, 26 in the frame 12, to prevent transverse and lateral movement of the internal slide 14 while permitting longitudinal movement of the internal slide 14 within the frame 12. In the preferred embodiment the device of the invention may have an external slide 16 comprising a hollow body 18 slidably received over the frame 12, and having a crosshair 19 to assist in visually aligning values on the scales 30, 32, 34, 36, described below.

To solve for the GFR according to the Cockcroft-Gault formula requires three arithmetic operations, a subtraction, a multiplication and a division, and operates over a restricted range of values for each variable. The range for each variable can be set out in finite scales 30, 32, 34, 36 disposed along the sets of mating edges 40, 42 of the internal slide 14 and the external slide 16.

The subtraction function (140−age) is equivalent to a single value directly correlated to the patient's age but inversely related. Thus, the age scale 34 ranges in a descending fashion relative to the weight scale 30, creatinine level scale 32 and GFR scale 36.

In order to perform multiplication operations (i.e. one multiplication and one division) to solve the Cockcroft-Gault formula, the multiplication operations are converted to addition operations by use of logarithmic functions, specifically:

log(a×b)=log(a)+log(b) (4)

Hence, since

a/b=a×b⁻¹ (5)

it follows that

log(a/b)=log(a)−log(b) (6)

Accordingly, using logarithms it is possible to multiply variables in the Cockcroft-Gault formula by adding corresponding logarithmic values. This is achieved by plotting the ranges of the three variables onto logarithmic scales 30, 32, 36. Adding the distances represented by the logarithmic scales is equivalent to adding the logarithms of the values, and thus multiplying the values.

The weight scale 30 is disposed on the frame 12 along the first mating edge, in opposition to the serum creatinine scale 32 which is disposed along the internal slide 14. The age variable (140−age) is disposed on the internal slide 14 along the second set of mating edges 42, in opposition to the GFR scale. For each variable, the scales are printed in such a way that the GFR result in the GFR scale 36 according to the Cockcroft-Gault formula is at the correct location on the frame 12 relative to the age scale 34 when the applicable values in the weight scale 30 and serum creatinine scale 32 are aligned along the first set of mating edges 40.

In operation, the healthcare provider aligns the measured serum creatinine value in the serum creatinine scale 32 against the weight value in the weight scale 30. The value on the GFR scale 36 opposite to the age value in the age scale 34 provides the patient's Glomular Filtration Rate.

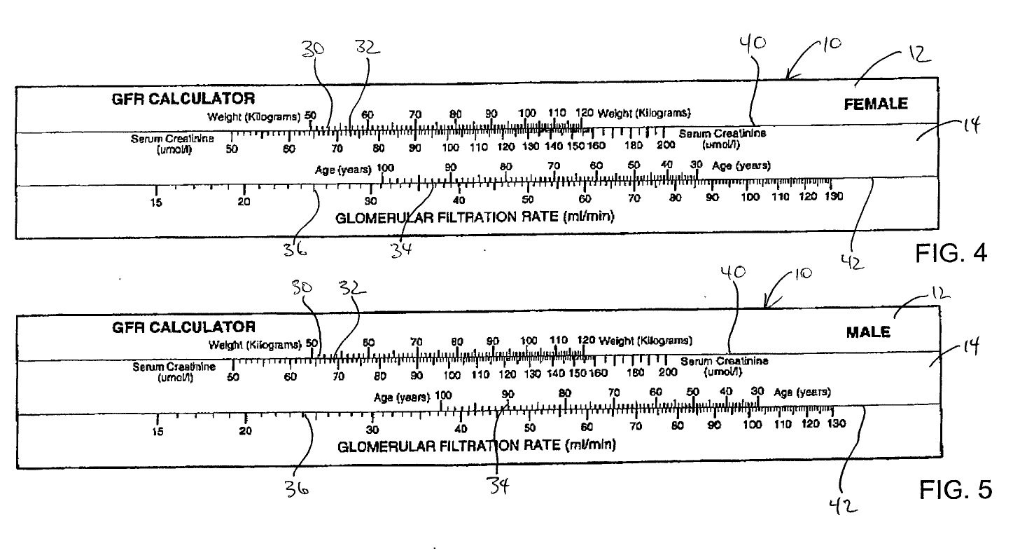

In the preferred embodiment the device 10 can provide either metric units of weight (kg) and serum creatinine (umol/ml), as in the embodiment of FIGS. 4 and 5, or imperial units of weight (lbs) and serum creatinine (mg/dL), as in the embodiment of FIGS. 1 and 2. The device 10 may be constructed from polystyrene extruded to high tolerance, with machine printed scales on both faces of the device 10 to provide values for male or female patients using a single device 10. Calibration of the scales 30, 32, 34, 36 can be achieved by a computer program written in any suitable programming language, for example Python, which converts the scales 30, 34, 36 to logarithmic equivalents and aligns the scales 30, 32, 34, 36. The program generates a postscript file that can be printed by any postscript printer or by using a previewer such as GhostScript.

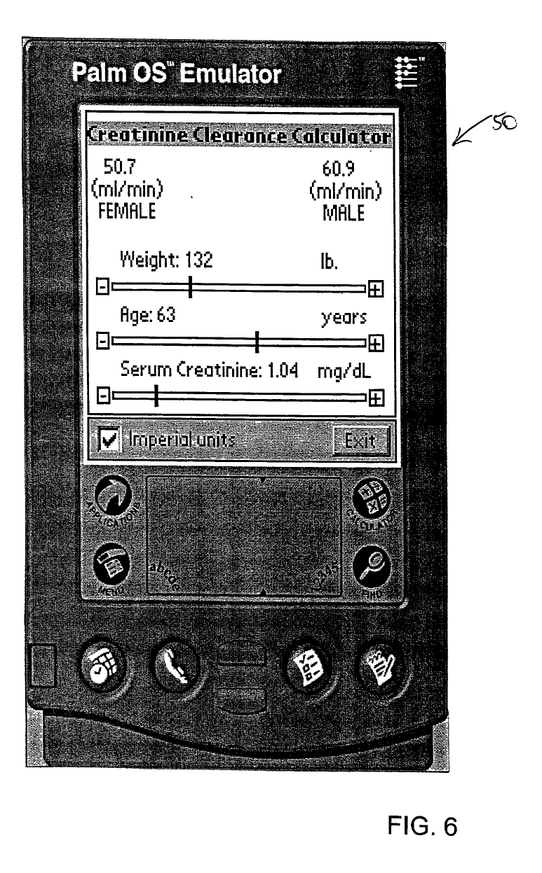

A computer program similar to the program which can be used to print the scales 30, 32, 34, 36 on the device 10 can also be used to effect the computation of the Glomular Filtration Rate according to the Cockcroft-Gault formula. An implementation of such a computer program is illustrated in FIG. 6, showing a user interface consisting of three slider scales for weight, age, and serum creatinine which can be dragged by a mouse or manipulated by selected keystrokes, for example in a hand-held processing device or calculator 50 such as that illustrated in FIG. 6. The output is recorded as GFR in ml/min on the top portion of the calculator 50 and can be given for both male and female genders. A toggle box allows the user to input variables in either metric or imperial units, and may include a drug database for quick reference. The computer program can also be implemented in a personal computer (PC) or other similar processing device.

The software can be written in the Java programining language. The graphical interface provides the three variables represented by separate scroll bars, which allows the user to change the value of any of the variables simply by moving the cursor of the respective graphical object (scroll bar). The software can be functional in Windows, MacIntosh, Unix, and any other environment.

Various embodiments of the present invention having been thus described in detail by way of example, it will be apparent to those skilled in the art that variations and modifications may be made without departing from the invention. The invention includes all such variations and modifications as fall within the scope of the appended claims.

I claim:

1. A device for calculating a Glomular Filtration Rate of a patient, comprising
a substantially planar frame,
an internal slide disposed within the frame in sliding relation, slidable in a longitudinal direction through the frame,
first and second sets of linear mating edges disposed between the frame and the internal slide, the first set of mating edges providing a first mating edge comprising a weight scale representing a logarithmic equivalent to a weight of the patient and a second mating edge comprising a creatinine scale representing a logarithmic equivalent to a creatinine level of the patient, the second set of mating edges providing a third mating edge comprising an age scale representing an age of the patient and a fourth mating edge comprising a GFR scale representing a logarithmic equivalent to a Glomular Filtration Rate of the patient,
whereby when the weight of the patient in the weight scale 30 is aligned with the creatinine level of the patient in the creatinine scale, Glomular Filtration Rate of the patient on the GFR scale is aligned with the age of the patient in the age scale.

2. The device of claim 1 in which the internal slide comprises tongues slidably received in grooves in the frame.

3. The device of claim 1 further comprising an external slide comprising a hollow body slidably received over the frame.

4. The device of claim 3 in which the external slide comprises a crosshair to assist in visually aligning values on the scales.

5. The device of claim 1 in which the frame and internal slide have opposite faces, the scales on the opposite faces being adapted to calculate the Glomular Filtration Rate of patients of opposite sexes.

6. The device of claim 1 in which the scales are calculated by a computer and printed on the device.
